(19) United States
(12) Patent Application Publication
(10) Pub. No.: US 2024/0356575 A1
(43) Pub. Date: Oct. 24, 2024

(54) METHOD AND SYSTEM FOR DETERMINING MATERIAL CONTENT

(71) Applicant: Oregon State University, Corvallis, OR (US)

(72) Inventors: Thomas McCrea Weller, Corvallis, OR (US); Ismail Uluer, Corvallis, OR (US); Jeff Frolik, Burlington, VT (US)

(73) Assignee: Oregon State University, Corvallis, OR (US)

(21) Appl. No.: 18/636,140

(22) Filed: Apr. 15, 2024

Related U.S. Application Data
(60) Provisional application No. 63/497,179, filed on Apr. 19, 2023.

(51) Int. Cl. H04B 1/40; G01N 27/12; H04B 1/3827; H04B 17/20; H04L 67/12

(52) U.S. Cl. CPC H04B 1/40; H04B 1/3827; H04B 17/202; H04L 67/12; G01N 27/121

(57) ABSTRACT

A wireless sensor network is described. The wireless sensor network comprises an interrogator transceiver operable to transmit a first wireless signal at a first RF frequency and to receive a second wireless signal at a second RF frequency to and from a wireless sensor node embedded within a medium. The medium comprises one or more dielectric materials. The wireless sensor node is interrogatable by the interrogator transceiver. The wireless sensor node is operable to receive the first wireless signal at the first RF frequency from the interrogator transceiver and to transmit the second wireless signal at the second RF frequency to the interrogator transceiver. A processor is coupled to a circuit within the interrogator transceiver. The circuit is operable to measure a power level of a received signal, and the processor is operable to correlate the power level of the received signal to a composition of the medium.

### CLAIM FOR PRIORITY

This application claims priority to U.S. Provisional Patent Application No. 63/497,179, filed on Apr. 19, 2023, titled “METHOD AND SYSTEM FOR DETERMINING MOISTURE CONTENT,” which is incorporated by reference in its entirety for all purposes.

### STATEMENT OF GOVERNMENT INTEREST

This invention was made with government support under grant number 693JJ620C000004 awarded by the US Department of Transportation (DOT). The government has certain rights in the invention.

### BACKGROUND

Long-term continuous wireless monitoring of the health of civil infrastructure is an active research area. Infrastructures are often subject to long-term deterioration that requires continuous non-destructive health assessment. For example, monitoring changes in the resonant vibration frequency of a bridge is a useful indicator of the bridge's integrity. Monitoring the moisture content in natural and build infrastructure can provide crucial information about structural integrity. When moisture content exceeds an acceptable level in such environments, infrastructure failures may occur. Railroads are one of the most used means of transportation for carrying passengers and freight. Railbed can become structurally compromised when the supporting ballast material becomes fouled and retains water. Above a certain moisture level, the ballast material is loosened, causing the railroad track to be prone to failure under load. Fast, accurate and continuous fault detection in the railroad track is important for the prevention of infrastructure failures that can cause accidents or disrupt train operations. Parameters of fault detection in railroad tracks include moisture level, vibration of the railroad track components (e.g., ballast material, subgrade, crossties), and displacement of the railroad track components. Current techniques for monitoring these parameters are expensive and time consuming, requiring significant human effort. Furthermore, they lack sufficient accuracy.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale and exact locations. For example, the dimensions of some elements can be exaggerated relative to other elements for clarity. Also, various physical features can be represented in their simplified “ideal” forms and geometries for clarity of discussion, but it is nevertheless to be understood that practical implementations can only approximate the illustrated ideals. For example, smooth surfaces and square intersections can be drawn in disregard of finite roughness, corner-rounding, and imperfect angular intersections characteristic of structures formed by nanofabrication techniques. Further, where considered appropriate, reference labels have been repeated among the figures to indicate corresponding or analogous elements.

FIG. 1 illustrates a block diagram of a wireless sensor network, in accordance with at least one embodiment.

FIG. 2 illustrates a pictorial view in cross-section of a wireless sensor network in accordance with at least one embodiment.

FIG. 3 illustrates a railroad deployment of wireless sensor network, in accordance with at least one embodiment.

FIG. 4 illustrates a 3D perspective view of a wireless sensor node, in accordance with at least one embodiment.

FIG. 5 illustrates a flow chart summarizing a method for operating a wireless sensor network, in accordance with at least one embodiment.

FIG. 6 illustrates a plot relating attenuation level of a response signal sent from a wireless sensor node to an interrogator transceiver as a function of moisture level, in accordance with at least one embodiment.

### DETAILED DESCRIPTION

A wireless sensor network for field monitoring of moisture content and other compositional properties of natural and artificial structural materials is described in accordance with at least one embodiment. In at least one embodiment, the wireless sensor network comprises passive harmonic transponders as interrogatable sensor nodes embedded within a structural material. In at least one embodiment, the wireless sensor network comprises at least one portable transceiver for interrogating the embedded sensor nodes. In at least one embodiment, the passive harmonic transponder sensor nodes are passive transponders that can receive low power radio frequency wireless signals at a fundamental frequency and transmit a harmonic of the fundamental frequency back to the transceiver without an external power supply. The power in the received wireless signal is sufficient to activate the transponder. In at least one embodiment, by determining the attenuation of the harmonic signal due to dielectric absorption as it travels through a structural material mixture, the content of a particular material component may be measured. In at least one embodiment, moisture content of a fouled railroad ballast material may be determined in this manner. Other components of a material mixture may be similarly determined as well, in accordance with at least one embodiment.

In at least one embodiment, a semiempirical approach to may be taken to model dielectric behavior of a material mixture and extract parameters such as the loss tangent (e.g., tan δ) of the mixture (e.g., at the harmonic signal frequency) as a function of the content (e.g., weight or volume percentage) of a component of the mixture. An example of a material mixture is railroad ballast material, comprising a mixture of gravel, coal dust and water (moisture). The measured loss tangent (tan δ) can be analytically related to the attenuation of the harmonic signal transmitted by the passive transponder as it travels through the material mixture.

In at least one embodiment, the harmonic signal is received by the interrogator transceiver. In at least one embodiment, a received-power level determining circuit within the interrogator transceiver may be coupled to a processor (e.g., in a computer), where an absolute (or relative) received power level of the harmonic response signal may be digitized and stored in a memory coupled to the processor. In at least one embodiment, processor may first determine the attenuation of the harmonic response signal due to dielectric interaction with a component of the mixture. In at least one embodiment, the processor may perform a comparison of the received power level of the response signal with a reference received power level. In at least one embodiment, the reference received power level may be stored as a constant in memory and recalled by software routines tasked with computing the content of the component within the mixture.

In at least one embodiment, the reference received power level may be a previously measured received power value of a harmonic response signal from a test bed comprising the same material mixture minus the component of interest. In at least one embodiment, the test bed comprises dry railroad ballast material (e.g., having a moisture content near zero percent). In at least one embodiment, from the measured attenuation, a calculated loss tangent (tan δ) value may be determined by the processor. In at least one embodiment, loss tangent may be proportional to the component content of the mixture. In at least one embodiment, loss tangent of wet railroad ballast material can be proportional to the moisture content within the wet railroad ballast material.

In at least one embodiment, the wireless sensor network comprises multiple sensor nodes. In at least one embodiment, wireless sensor nodes may each comprise identical passive harmonic transponders. In at least one embodiment, a wireless sensor node is compact (e.g., having overall dimensions that fit within a 30 mm diameter sphere). In at least one embodiment, a wireless sensor node comprises a first antenna operable to receive an interrogation signal at a first RF frequency, and a second antenna operable to transmit a response signal at a second RF frequency. In at least one embodiment, the passive harmonic transponder comprises a passive frequency multiplier circuit between the first antenna and the second antenna. In at least one embodiment, first antenna is coupled to the input of the frequency multiplier circuit. The second antenna is coupled to the output of the frequency multiplier circuit.

In at least one embodiment, the frequency multiplier circuit comprises a diode as the non-linear circuit element. In at least one embodiment, diode may be a Schottky diode, having a low turn-on voltage and a low input capacitance. The non-linear I-V characteristics of a diode may produce harmonics of an excitation signal, such as the interrogation signal. A figure of merit for such a frequency multiplication circuit is conversion gain (CG). Conversion gain may be defined as a ratio of output power to input power of the frequency multiplier circuit. In at least one embodiment, the frequency multiplier circuit of a sensor node has a CG of at least −15 dB relative to an input signal strength of −30 dBm (e.g., 1 microwatt) of the interrogation signal at an optimum frequency of the interrogation signal. Thus, at the output of the frequency multiplier circuit, the harmonic signal power is at most 15 dB below the input signal power. When increased by transmit antenna gain of approximately 2 dBi, the response signal transmitted by the sensor node may be −13 dB below the received power level of the interrogation signal (e.g., −30 dBm, or 1 microwatt).

The received power level is defined as the power level of the interrogation signal when received by the sensor node and introduced at the input of the frequency multiplier circuit, and not the power level of the signal when launched from the interrogator transceiver. In at least one embodiment, interrogation signal may be attenuated prior to reception by the sensor node by a combination of square law attenuation with distance, backscattering, diffraction, reflections causing multipath effects and absorption along its propagation path through the medium. Thus, its initial power may be significantly diminished due to these effects. In at least one embodiment, received power levels of the interrogation signal may range between −30 dBm and −20 dBm, corresponding to 1 microwatt to 10 microwatts. In at least one embodiment, the distance between the sensor node and the interrogator transceiver may range up to 50 meters, according to at least one embodiment. In at least one embodiment, the sensor node may be embedded up to 100 cm below the surface of the medium.

In at least one embodiment, the interrogation signal has a frequency greater than 1 GHz. In at least one embodiment, the interrogation signal has a frequency between 2 and 3 GHZ. For example, the frequency of the interrogation signal is 2.4 GHz. In at least one embodiment, the interrogation signal is an unmodulated pure sinewave. In at least one embodiment, the response signal is the second harmonic of the interrogation signal. For example, the response signal has a frequency of 4.8 GHz. In at least one embodiment, the interrogation signal may be 1.2 GHz, whereas the response signal may be 2.4 GHz. The frequencies quoted here are exemplary; other suitable frequencies may be employed. Frequencies may be chosen based on their ability to interact with a material of interest in a multicomponent dielectric medium. The size of the sensor node may be scaled accordingly.

Here, numerous specific details are set forth, such as structural schemes, to provide a thorough understanding of at least one embodiment. It will be apparent to one skilled in art that embodiments of present disclosure can be practiced without these specific details. In other instances, well-known features are described in lesser detail to not unnecessarily obscure at least one embodiment. Furthermore, it can be understood that at least one embodiment shown in a figure can be an illustrative representation and may not be necessarily drawn to scale.

In some instances, well-known methods and devices are shown in block diagram form, rather than in detail, to avoid obscuring at least one implementation or embodiment. Reference throughout this specification to “an embodiment” or “at least one embodiment” or “one embodiment” or “some embodiments” means that a particular feature, structure, function, or characteristic described in connection with implementation can be included in at least one implementation. Thus, appearances “in an embodiment” or “in one embodiment” or “in at least one embodiment” or “some embodiments” in various places throughout this specification are not necessarily referring to a same embodiment. Furthermore, particular features, structures, functions, or characteristics can be combined in any suitable manner in at least one embodiment. For example, a first embodiment can be combined with a second embodiment anywhere particular features, structures, functions, or characteristics associated with first embodiment and second embodiment are not mutually exclusive.

Here, “coupled” and “connected,” along with their derivatives, can be used to describe functional or structural relationships between components. These terms are not intended as synonyms for each other. Rather, in particular embodiments, “connected” can be used to indicate that two or more elements are in direct physical, optical, or electrical contact with each other. Here “coupled” can be used to indicate that two or more elements are in either direct or indirect (with other intervening elements between them) physical, electrical or in magnetic contact with each other, and/or that two or more elements co-operate or interact with each other (e.g., as in a cause an effect relationship).

Here, “over,” “under,” “between,” and “on” can generally refer to a relative position of one component or material with respect to other components or materials where such physical relationships are noteworthy. Unless these terms are modified with “direct” or “directly,” one or more intervening components or materials can be present. Similar distinctions are to be made in context of component assemblies. As used throughout this description, and in claims, a list of items joined by “at least one of” or “one or more of” can mean any combination of listed terms.

Here, “adjacent” can generally refer to a position of a thing being next to (e.g., immediately next to or close to with one or more things between them) or adjoining another thing (e.g., abutting it).

Unless otherwise specified in explicit context of their use, “substantially equal,” “about equal” and “approximately equal” can generally mean that there can be no more than incidental variation between two things so described. In at least one implementation, such variation can be no more than +/−10% of a referred value.

Here, “interrogator transceiver” may generally refer to a wireless transceiver operational on radio frequencies, such as microwave band frequencies above 900 MHz, for example. In at least one embodiment, an interrogator transceiver is operable to transmit an interrogation signal and receive a response signal as a return signal to and from a wireless sensor node. A transceiver is operable to both transmit and receive RF signals.

Here, “RF signal” may generally refer to a radio frequency (RF) unmodulated or modulated sinusoidal signal.

Here, “wireless signal” may generally refer to a radio frequency signal that propagates over the air.

Here, “interrogation signal” may generally refer to a wireless signal that is sent by an interrogator transceiver to a wireless sensor node. In at least one embodiment, interrogation signal may spontaneously excite a response signal from the wireless sensor node. The interrogation signal may be sent at a frequency f₀.

Here, “response signal” may generally refer to a wireless signal that is excited by reception of an interrogation signal sent by an interrogator transceiver to a wireless sensor node. In at least one embodiment, the wireless sensor node may be operable to transmit a response signal that is a harmonic of the frequency f₀ of interrogation signal.

Here, “medium” may generally refer to a bed or block comprising one or more dielectric materials. In at least one embodiment, a medium may comprise air, water, stone, and/or coal dust.

Here, “ballast material” may generally refer to a medium comprising a structural material such as gravel. In at least one embodiment, a ballast material may be gravel piled in long rows as substructure to support other structures. In at least one embodiment, a ballast may support a railroad track or rail.

Here, “dielectric material” may generally refer to an electrically non-conductive material such as water, air, stone, glass, concrete, etc.

Here, “moisture content” may generally refer to a level of water contained by a material mixture. In at least one embodiment, moisture content may be expressed as a weight or volumetric percentage.

Here, “wireless sensor node” may generally refer to a passive transponder (a transponder is an electronic device that receives a first signal at a first frequency and transmits a second signal at a different frequency) that is operable to return a response signal to an interrogator transceiver. In at least one embodiment, response signal may be excited by an interrogation signal transmitted by the interrogation transceiver. In at least one embodiment, a wireless sensor node may be buried or embedded within a medium.

Here, “foam enclosure” may generally refer to a structural housing for a buried wireless sensor node. In at least one embodiment, a foam enclosure may comprise a polymer foam material. In at least one embodiment, a polymer foam material may be a Styrofoam or a polyurethane foam. In at least one embodiment, the foam enclosure may provide structural protection of the wireless sensor node. In at least one embodiment, a foam construction of the housing may have a dielectric constant close to that of air.

Here, “circuit” may generally refer to a network of electronic components that are interconnected in such a way that a signal presented at an input to the circuit is transformed in some way by the interaction of the electronic components.

Here, “frequency” may generally refer to the number of cycles per second regarding a sinusoidal RF signal.

Here, “harmonic” may generally refer to frequency that is a multiple of a fundamental frequency of an RF signal.

Here, “frequency multiplier circuit” may generally refer to a circuit specialized to produce harmonics of an input signal having a fundamental frequency. In at least one embodiment, frequency multiplier circuit may employ a non-linear element such as a semiconductor diode. In at least one embodiment, non-linear element has a non-linear current-voltage (I-V) characteristic that can generate harmonics of an excitation signal.

Here, “diode” may generally refer to a non-linear passive circuit element that permits conduction in one direction. In at least one embodiment, diodes may be vacuum tube or solid-state devices. In at least one embodiment, a solid-state diode comprises a semiconductor material that can have a bipolar junction between a p-type material and a n-type material. In at least one embodiment, a Schottky diode possesses a semiconductor-metal junction, having far less junction capacitance than a p-n junction diode for higher frequency response and lower forward voltage threshold. In at least one embodiment, a diode has a non-linear I-V characteristic that enables it to generate harmonics of a fundamental signal presented at its input.

Here, “passive device” may generally refer to an electric circuit element or circuit that does not require an external power source to operate on a voltage or current. For example, a passive device may be a resistor, a capacitor, an inductor or a diode. By virtue of their construction and materials, a current passing through them may be attenuated in some manner or rectified. A distinction is made with respect to active devices, such as transistors and vacuum tubes, which require an external power source. A circuit composed only of passive devices is also a passive device.

Here, “antenna” may generally refer to a conductive (usually metal) structure that can receive and/or transmit electromagnetic waves at RF frequencies. In at least one embodiment, antennas may both receive and transmit antennas.

Here, “receive antenna” may generally refer to an antenna operable to capture electromagnetic waves propagating through space or through air. In at least one embodiment, receive antenna may be an antenna dedicated to receiving, and may not transmit. In at least one embodiment, receive antenna may also be capable of transmission of electromagnetic waves, but employed for reception of signals, such as a television antenna or broadcast radio antenna.

Here, “transmit antenna” may generally refer to an antenna operable to launch electromagnetic waves into space or air. In at least one embodiment, while a transmit antenna can receive electromagnetic waves, it may be employed for transmission of electromagnetic waves, such as a radio broadcast antenna.

Here, “processor” may generally refer to a central processing unit or a microprocessor that executes binary code.

Here, “measured power level” may generally refer to a quantity that is a power level of a RF signal sampled in a receiver circuit that is operational to convert the power level of the RF signal to an analog voltage that is proportional to the power level of the received signal. In at least one embodiment, the analog voltage may be calibrated to measured power of RF signals. In at least one embodiment, the analog voltage may be digitized and read by a processor.

Here, “reference power level” may generally refer to a known or pre-measured power level of an unattenuated signal to which the measured power level of an attenuated signal may be compared for quantitative determination of the attenuation of the attenuated signal.

Here, “received signal” may generally refer to an RF signal that is received by a radio receiver or transceiver.

Here, “attenuation” may generally refer to a diminution of signal power.

Here, “loss tangent” may generally refer to a quantity that is a measure of power loss due to interaction with a dielectric material. In at least one embodiment, a loss tangent is generally expressed as a tan δ, where δ is a phase angle between the real (ε′) and the imaginary (ε″) components of a dielectric constant ε of a material. In at least one embodiment, larger the loss tangent, the greater the power loss due to dielectric interactions. In many materials, the loss tangent is due to coupling of electromagnetic energy with lattice or molecular motion in solids or liquids, and to a lesser extent in some gases. In at least one embodiment, imaginary part ε″ of the dielectric constant reflects this type of interaction, thus expressed as ε″ α sin δ and ε′ α cos δ.

Here, “mobile vehicle” may generally refer to a movable structure operable to travel by various means. In at least one embodiment, a vehicle may be an automobile traveling on a road or a railroad train traveling on a rail or track. In at least one embodiment, a mobile vehicle may be operable to fly, such as a drone or plane.

Here, “rail” may generally refer to a railroad track.

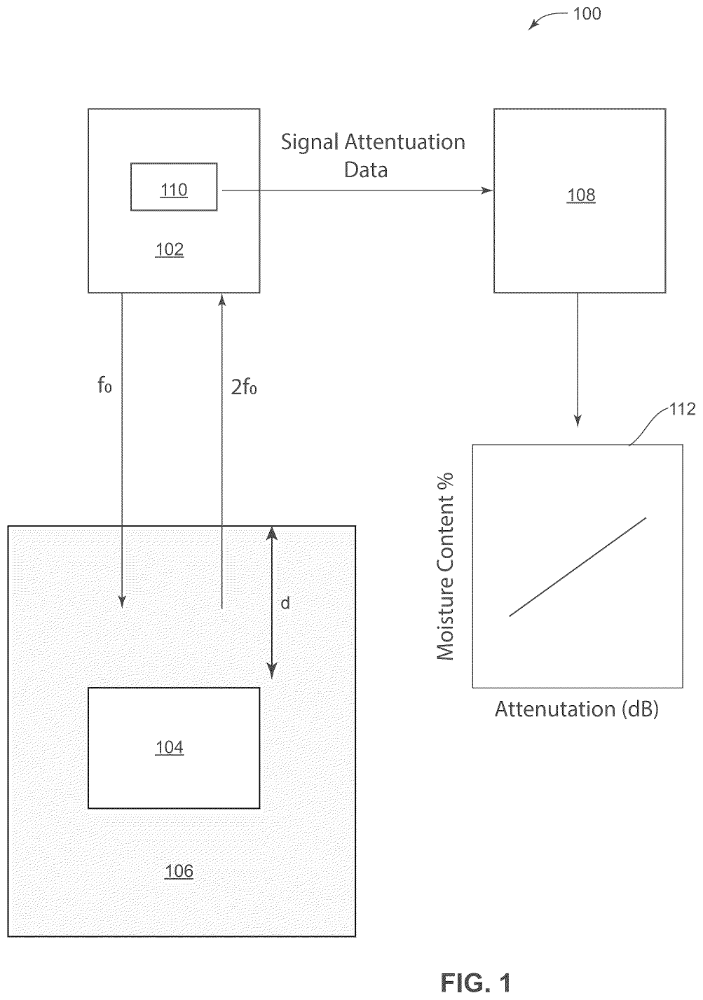

FIG. 1 illustrates a block diagram of a wireless sensor network 100, in accordance with at least one embodiment. In at least one embodiment, wireless sensor network 100 comprises (wireless) interrogator transceiver 102 that is wirelessly linked over air propagation of radio frequency (RF) signals to wireless sensor node 104. In at least one embodiment, wireless sensor node 104 is housed in a foam enclosure. In at least one embodiment, wireless sensor node 104 comprises a passive transponder that is operable to receive an interrogation signal at a first RF frequency transmitted from interrogator transceiver 102. In at least one embodiment, transponder is operable to transmit a response signal to the interrogator transceiver 102 at a second RF frequency. In at least one embodiment, wireless sensor node 104 is a passive device, requiring no external power source. Power is derived from the received interrogation signal.

In at least one embodiment, second RF frequency is a harmonic of the first RF frequency. In at least one embodiment, second RF frequency is the first harmonic (2f₀) of the first RF frequency (f₀). In at least one embodiment, wireless sensor node is embedded within medium 106 a distance d below a top surface of medium 106. In at least one embodiment, medium 106 comprises a mixture of one or more dielectric materials. In at least one embodiment, medium 106 is a porous medium (e.g., having 60% or greater porosity). In at least one embodiment, a mixed-material medium is railroad ballast material, comprising gravel, coal dust and water (moisture).

In at least one embodiment, processor 108 is coupled to interrogator transceiver 102. In at least one embodiment, processor 108 is coupled to a received power sensing circuit 110 within interrogator transceiver 102. In at least one embodiment, a received power sensing circuit within a radio receiver may provide an analog voltage or binary data indicative of the level of the power of a received signal available at the output of the receive antenna. In at least one embodiment, processor 108 is operable to determine an attenuation of the response signal (e.g., at 2f₀) transmitted from sensor node 104 to interrogator transceiver 102.

In at least one embodiment, response signal may be attenuated along its propagation path significantly by absorption within medium 106. In at least one embodiment, materials within medium 106 may absorb energy of the emitted microwaves by dielectric loss mechanisms within the materials. In at least one embodiment, loss due to dielectric interactions may be expressed by tan δ, where δ is a phase angle between the real and imaginary parts ε′ and ε″, respectively, of the dielectric constant of the material when the two phasors are plotted on an imaginary plane as ε″(ε′). In at least one embodiment, tan δ loss may be a frequency-dependent quantity as the values of ε′ and ε″ may be frequency dependent over frequencies of interest. Other mechanisms of signal attenuation may include absorption by other materials in the medium, as well as reflections and diffraction of the emitted microwaves, in accordance with at least one embodiment. In at least one embodiment, distance between interrogator transceiver 102 and sensor node 104 may also be considered, as signal power decreases according to an inverse square law. These mechanisms may constitute unchanging background attenuation that may be subtracted from the correlation with a particular mixture component, such as moisture (water).

The greater the value of tan δ, the higher the loss. In at least one embodiment, attenuation of a signal passing through medium 106 of the response signal is mathematically related to the tan δ loss of the medium. In at least one embodiment, magnitude of tan δ loss of the response signal caused by the medium may be empirically correlated with the content (e.g., percentage by weight or volume) of a particular component of the material mixture of the medium. In at least one embodiment, measured attenuation of the response signal may be correlated with moisture content of the medium.

In at least one embodiment, processor 108 is operable to determine the attenuation of the response signal by comparison of the measured received power of the response signal having propagated through a wet medium to a pre-measured received power of a response signal having propagated through substantially the same medium but dry (zero moisture). In at least one embodiment, processor 108 may be calibrated by empirical or calculated data stored in a memory coupled to processor 108 (not shown). In at least one embodiment, a lookup table 112 containing data relating attenuation to moisture level may be stored in memory and accessible by processor 108.

While moisture levels within mixed material media such as railroad ballast material, soil or sand may be correlated to response signal attenuation, other components of a mixed-material medium may also be similarly assessed.

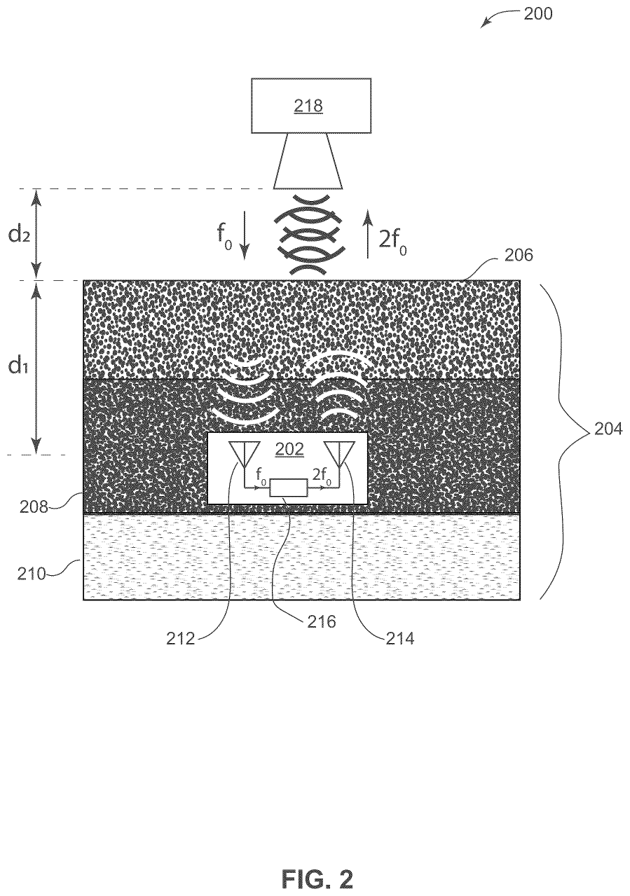

FIG. 2 illustrates a pictorial view in cross-section of a wireless sensor network 200 in accordance with at least one embodiment. In at least one embodiment, wireless sensor network 200 comprises at least one wireless sensor node 202 embedded within medium 204. In at least one embodiment, medium 204 may be a mixed-material medium, comprising one or more dielectric materials. In at least one embodiment medium 204 comprises a railroad ballast material. In at least one embodiment, relatively clean railroad ballast material comprising gravel is confined to a top portion 206. Top portion 206 may be substantially dry as water may readily drain through the porous structure. A fouled mixture comprising gravel, coal dust and moisture is within bottom portion 208. Fouled ballast material may be wet as porosity may be filled by coal dust and soil, preventing drainage of the fouled portion. In at least one embodiment, wireless sensor node 202 is buried a depth d₁ within medium 204 within bottom portion 208. In at least one embodiment, medium 204 may be located above a substratum 210. In at least one embodiment, depth d₁ may be 100 cm or less.

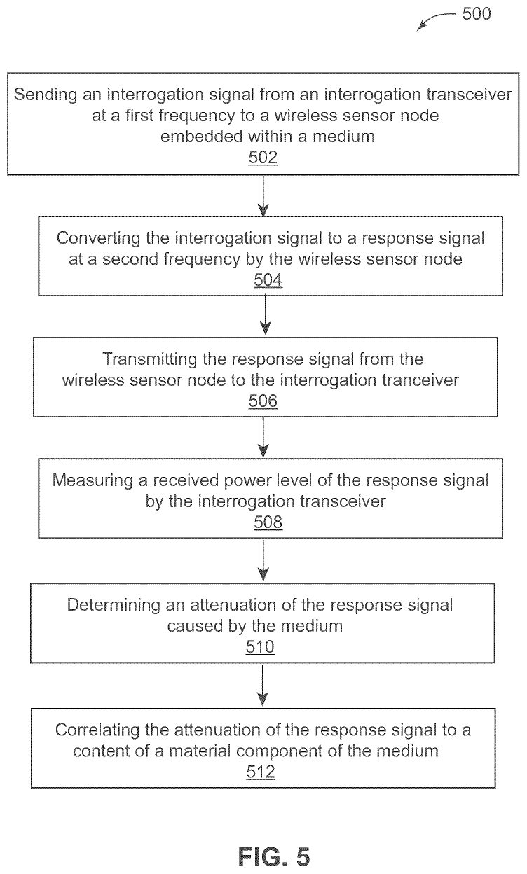

In at least one embodiment, wireless sensor node 202 comprises receive antenna 212, transmit antenna 214, and frequency multiplier circuit 216. In at least one embodiment, receive antenna 212 and transmit antenna 214 are operable to receive and send interrogation signals and response signals, respectively, from and to interrogator transceiver 218. In at least one embodiment, frequency multiplier circuit 216 is a passive circuit, requiring no external DC power source. In at least one embodiment, wireless sensor node 202 to operate without a requirement for a power source, such as a battery, to be collocated with it. In at least one embodiment, wireless sensor node 202 may be buried indefinitely. In at least one embodiment, frequency multiplier circuit 216 is coupled to a DC bias source. In at least one embodiment, frequency multiplier circuit 216 comprises at least a diode (see FIG. 5) as a non-linear circuit element. In at least one embodiment, the diode may have a low forward voltage threshold to conduct, as may be an I-V characteristic for a Schottky diode or a germanium diode. In at least one embodiment, a Schottky diode may have a forward conduction voltage threshold of 1 mV, which may be supplied on positive voltage peaks of an RF voltage at the input (anode) of the diode.

In at least one embodiment, the non-linear I-V characteristic of frequency multiplier circuit 216 may produce a Fourier series of harmonics of the fundamental frequency f₀ of the interrogation signal (e.g., 2f₀, 3f₀, 4f₀, etc.). In at least one embodiment, amplitude of the harmonic components decreases as the order of the harmonic increases. In at least one embodiment, transmit antenna 214 is operable to transmit the response signal at a frequency that is the first harmonic (2f₀) of the frequency f₀ of the interrogation signal. For example, the input impedance of transmit antenna 214 is matched by a matching network comprising lengths of transmission line to the output impedance of frequency multiplier circuit 216 (e.g., diode) such that the reflection coefficient is near zero at 2f₀, with sharp increases at nearby frequencies. In at least one embodiment, narrow bandwidth of the matching network effectively filters out the other harmonics and the fundamental. In at least one embodiment, alternative harmonics may be chosen by providing a matching network designed for the desired harmonic. In at least one embodiment, the interrogation signal has a frequency f₀ that is 1 GHz or greater. In at least one embodiment, the interrogation signal has a frequency f₀ that is 2 GHz or greater. For example, f₀ may be approximately 2.4 GHz. In at least one embodiment, response signal may be transmitted at 2f₀, or approximately 4.8 GHz. In at least one embodiment, f₀ is 1.2 GHZ, and 2f₀ is 2.4 GHz.

In at least one embodiment, both the interrogation signal and the response signal are subject to attenuation by medium 204. In at least one embodiment, interrogator transceiver 218 may be located at an optimal distance from wireless sensor node 202, considering backscattering, multipath reflection, diffraction and absorption along the propagation path of the interrogation signal through medium 204. In at least one embodiment, interrogator transceiver 218 is operable to transmit the interrogation signal at an effective radiated power enabling a received power between −30 dBm and −20 dBm (e.g., between 1 microwatt and 10 microwatts) at the input of frequency multiplier circuit 216. In at least one embodiment, −30 dBm may be a threshold value as a minimum peak voltage is required for forward conduction of the diode. In at least one embodiment, maximum power transfer from receive antenna 212 to the input of frequency multiplier circuit 216 may be achieved by an employment an input matching network to conjugate match the antenna impedance of receive antenna 212 to the input impedance of the frequency multiplier circuit 216 (e.g., diode).

In at least one embodiment, frequency multiplier circuit 216 may be operational to produce a conversion gain (CG) of at least −15 dB (e.g., output power approximately 1/30^{th} of the input power), where the conversion gain may be defined as CG=Pₒᵤₜ/Pᵢₙ, where Pᵢₙ is the power of the interrogation signal at f₀ present at the input of frequency multiplier circuit 216, and Pₒᵤₜ is the power of the response signal at 2f₀, for example, presented to the transmit antenna. For example, the power of the response signal at the input of the transmit antenna may be −45 dBm (e.g., approximately 300 nanowatts at 2f₀).

In at least one embodiment, interrogator transceiver 218 may be designed to transmit the interrogation signal at an effective radiated power sufficient to supply a signal strength of −30 dBm at the input of frequency multiplier circuit 216 from a minimum distance d₁+d₂ from wireless sensor node 202, taking into account attenuation from medium 204. Depth d₁ has been defined above, and d₂ is a vector distance between interrogator transceiver 218 and the x-y position of wireless sensor node 202 on the surface of medium 204. In at least one embodiment, distance d₂ may be 50 meters or less. For example, interrogator transceiver 218 may have an effective radiated power (EIRP, effective radiated power quoted with respect to an isotropic radiator) of 16 dBm (approximately 40 mW) for a wireless sensor node buried up to 40 cm in railroad ballast at 1.2 GHZ.

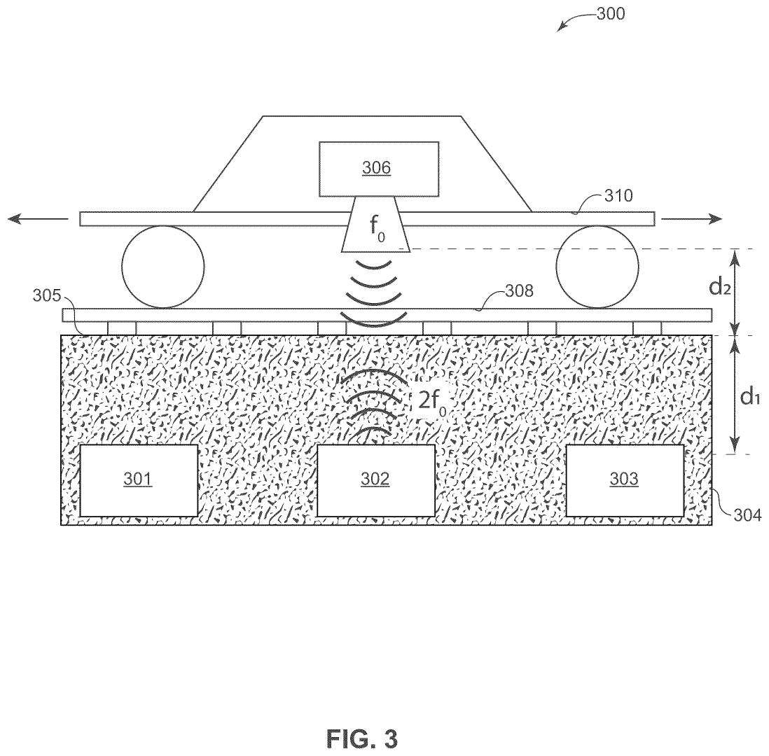

FIG. 3 illustrates a railroad deployment of wireless sensor network 300, in accordance with at least one embodiment. In at least one embodiment, wireless sensor network 300 comprises multiple wireless sensor nodes 301, 302, and 303 embedded within ballast material 304 by a distance d1 below surface 305. In at least one embodiment, ballast material 304 is a railroad ballast material, comprising principally dry gravel. Railroad ballast material can be fouled with a material such as coal dust and soil, which may retain moisture by blockage of porosity within the gravel matrix (e.g., 5-8 cm stone size). Thus, railroad ballast material can be a mixed-material medium comprising multiple dielectric materials, including water.

In at least one embodiment, in the deployment of wireless sensor network 300 shown in FIG. 3, interrogator transceiver 306 is transported along rail 308 by a mobile rail vehicle 310. In at least one embodiment, rail vehicle 310 may be a train, a locomotive, or other rail-bound vehicle. In at least one embodiment, rail vehicle 310 may be a non-rail bound vehicle, such as an automobile, truck or drone. In at least one embodiment, interrogator transceiver 306 may be carried by hand. In at least one embodiment, interrogator transceiver 306 may be transported along rail 308 to interrogate multiple wireless sensors nodes 301, 302, 303 and more distributed at intervals a distance d₁ below rail 308 within ballast material 304. In at least one embodiment, interrogator transceiver 306 may be moved to minimal distances d₂+d₁ from each wireless sensor node 301-303, etc., where d₂ may be approximately one or two meters, for example. In at least one embodiment, response signals excited by the interrogation signal transmitted by interrogator transceiver 306 may be received by interrogator transceiver and recorded by an embedded processor (e.g., processor 108, FIG. 1) or by a portable computer coupled to interrogator transceiver 306. In at least one embodiment, each wireless sensor may have a different environment, thus a mapping of moisture levels along rail 308 at any time may be readily developed. Moisture levels along a rail such as rail 308 may be readily monitored on a regular basis to keep track of moisture buildup within ballast material 304. In at least one embodiment, moisture buildup above a critical level may cause slippage of ballast material leading to derailment of trains. In at least one embodiment, deployment of a wireless sensor network such as wireless sensor network 300 may enable early warning of such incidents and thus avoidance of rail accidents due to deterioration of ballast material.

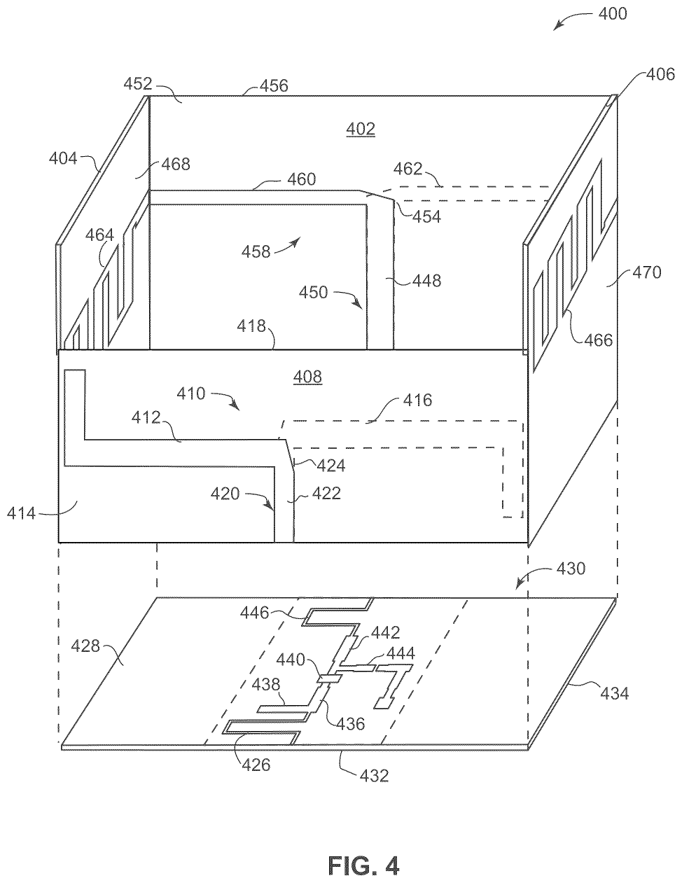

FIG. 4 illustrates a 3D perspective view of wireless sensor node 400, in accordance with at least one embodiment. In at least one embodiment, wireless sensor node 400 comprises front wall 402, side walls 404 and 406, and rear wall 408. In at least one embodiment, wireless sensor node 400 may be dimensioned to fit within a sphere having a diameter of 30 mm. In at least one embodiment, dimensions may be optimized for optimal antenna sizes, which can in part depend on f₀. In at least one embodiment, walls may be constructed from printed circuit board materials such as a dual-laminated polymeric dielectric (e.g., Rogers 3010, having a relative dielectric constant εᵣ˜10) with copper laminations on one or both sides. In at least one embodiment, transmit antenna 410 is a dipole patterned (e.g., by etching) in copper lamination on both sides of rear wall 408. In at least one embodiment, transmit antenna 410 comprises leg 412 patterned on outer side 414 of rear wall 408, and leg 416 (shown by hidden lines) is patterned on inner side 418 of rear wall 408. In at least one embodiment, legs 412 and 416 are folded orthogonally to fit on rear wall 408. In at least one embodiment, dimensions of legs 412 and 416 may be optimized for maximal gain and efficiency of transmit antenna 410. In at least one embodiment, legs 412 and 416 are fed by a parallel plate balun 420 formed by outer plate 422 on outer side 414 and inner plate 424 on inner side 418 of rear wall 408.

In at least one embodiment, inner plate 424 of balun 420 located on inner side 418 is coupled to meandered strip line transmission line segment 426 on upper side 428 of bottom wall 430. In at least one embodiment, outer plate 422 of balun 420 may be coupled to a ground plane 432 (shown by hidden lines) on lower side 434 of bottom wall 430. In at least one embodiment, outer plate 422 and inner plate 424 of balun 420 have a length of approximately a quarter wavelength at the frequency of interest (e.g., 2f₀). The quarter-wave length of balun 420 establishes a common mode high-impedance point near the feed point of transmit antenna 410. In at least one embodiment, high impedance point may suppress common mode currents resulting to imbalances of transmit antenna 410. In at least one embodiment, transmission line segment 426 may have a first characteristic impedance. In at least one embodiment, transmission line segment 426 may be coupled to transmission line segment 436 having a second characteristic impedance, different from the first characteristic impedance.

Due to manufacturing variability, both thickness and dielectric constant of the dielectric substrate material between copper laminations may vary. Such variation may cause variations in characteristic impedances of transmission lines used in the impedance matching networks, for example. Such variations may also cause small changes in the resonant frequencies of the receive and transmit antennas as well. Thus, resonances may occur at frequencies other than those intended. The narrow bandwidth matching networks may be peaked at different frequencies, causing f₀ and 2f₀ to have large reflection coefficients at the antenna feed points. In at least one embodiment, the characteristic impedances of both input and output transmission lines (e.g., comprising transmission line segments 426 and 436) may be mechanically tuned by positioning an additional dielectric material on or near bottom wall 430, The additional dielectric material may be positioned on or near the transmission line segments, causing their characteristic impedances to change. Such employment of dielectric material may be performed mechanically by positioning dielectric blocks on bottom wall 430 may tune the impedances for tuning matching networks to the working frequencies (e.g., f₀ and 2f₀). In at least one embodiment, an adjustable mechanism such as a screw mechanism may be employed to move a dielectric shape toward and away from the matching networks to affect their characteristic impedances. The mechanical tuning may be performed during manufacture or prior to burial of wireless sensor node 400.

In at least one embodiment, impedance matching stub 438 may extend from transmission line segment 436. In at least one embodiment, transmission line segment 436 is coupled to the cathode (e.g., negative) terminal of diode 440. In at least one embodiment, cathode terminal is the output terminal of diode 440. In at least one embodiment, an impedance matching network is formed by the combination of transmission line segment 426, transmission line segment 436 and matching stub 438. In at least one embodiment, impedance matching network is operable to transform the antenna impedance to match the output impedance of diode 440, enabling a conjugate match of antenna impedance to diode output impedance at the frequency of interest (e.g., 2f₀). As noted above, frequency multiplier circuit 216, shown in FIG. 2, comprises at least one diode as the non-linear element, operable to generate harmonics of the input signal frequency. In at least one embodiment, diode 440 is operable to function as the non-linear element of frequency multiplier circuit 216. In at least one embodiment, diode 440 may be a Schottky diode, exhibiting very low input capacitance (for high frequency response) and a small forward voltage threshold (e.g., 1-10 mV). In at least one embodiment, anode (e.g., positive) terminal of diode 440 is the input terminal of diode 440, and is coupled to transmission line segment 442. In at least one embodiment, diode 440 is not biased or powered externally, and as such is a passive circuit element.

In at least one embodiment, transmission line segment 442 may be coupled to a DC bias network 444. In at least one embodiment, DC bias network 444 may comprise an impedance matching stub and pads for surface mount choke inductor and bypass capacitor. In at least one embodiment, DC bias network 444 may be coupled to a DC voltage source, such as a battery or a piezoelectric element, for providing steady or changing DC bias to the input of diode 440. In at least one embodiment, a changing DC bias may be caused by vibrations, enabling wireless sensor node 400 to send amplitude-modulated response signals that may carry information related to mechanical vibration frequencies and amplitudes to which wireless sensor node 400 is subjected.

In at least one embodiment, transmission line segment 442 is coupled to meandered transmission line segment 446. In at least one embodiment, transmission line segment 446 is coupled to inner plate 448 of balun 450. In at least one embodiment, inner plate 448 extends vertically (in the z-direction) from bottom wall 430, on inner side 452 of front wall 402. Balun 450 also comprises outer plate 454 (shown by hidden lines) extending vertically on outer side 456 of front wall 402. In at least one embodiment, outer plate 454 is coupled to ground plane 432. In at least one embodiment, inner plate 448 and outer plate 454 are parallel to one another, and have a quarter wavelength long dimension at the frequency of interest (e.g., f₀) together with the segment of structural dielectric between them, develop a common mode high impedance point at the feedpoint of receive antenna 458 to enable suppression of common mode currents that may be generated in receive antenna 458.

In at least one embodiment, receive antenna 458 is a dipole, comprising leg 460 patterned on inner side 452 of front wall 402, and extending laterally. In at least one embodiment, receive antenna 458 comprises leg 462 (shown by hidden lines), patterned on outer side 456 of front wall 402. In at least one embodiment, receive antenna 458 comprises meandered segments 464 and 466, coupled to leg 460 and leg 462, respectively. In at least one embodiment, meandered segment 464 is patterned on inner side 468 of side wall 404, whereas meandered segment 466 is patterned on outer side 470 of side wall 406. In at least one embodiment, meandered segments 464 and 466 are extensions of legs 460 and 462, enabling the physical length of legs 460 and 462 to be shorter compared to straight dipole legs tuned for the same frequency of interest (e.g., f₀).

In at least one embodiment, incorporation of meandered segments 464 and 466 as extensions of legs 460 and 462 on orthogonal walls enables receive antenna 458 to have a folded configuration while accommodating the physical length of receive antenna 458, decreasing the overall footprint of wireless sensor node 400. In at least one embodiment, receive antenna 458 may be significantly physically larger than transmit antenna 410 as receive antenna 458 may be tuned to resonate near f₀ and transmit antenna 410 may be tuned to resonate near 2f₀. In at least one embodiment, by incorporation of meandered segments 464 and 466 in receive antenna 458, the overall dimensions of wireless sensor node 400 may be smaller. In at least one embodiment, lengths of legs 460 and 462, as well as dimensions of meandered segments 464 and 466, may be optimized to enable receive antenna 458 to have maximal gain and efficiency.

FIG. 5 illustrates flow chart 500 summarizing a method for operating a wireless sensor network, in accordance with at least one embodiment. In at least one embodiment, at operation 502, an interrogation signal is sent from an interrogator transceiver (e.g., any of interrogator transceivers 102, 218 or 306) to a wireless sensor node, such as any of wireless sensor nodes 104, 202, or 302, embedded within a medium comprising one or more dielectric materials. In at least one embodiment, the medium is wet fouled railroad ballast material, described above.

In at least one embodiment, interrogator transceiver may be operational to send an unmodulated microwave carrier at a frequency of f₀, where f₀ may be 1 GHz or greater. In at least one embodiment, the interrogation signal may be attenuated by passage through the medium to arrive at the receive antenna of the buried wireless sensor node. In at least one embodiment, attenuation may be due to any combination of absorption, backscattering, diffraction and multipath effects of materials within the medium. In at least one embodiment, effective radiated power of the interrogation signal may be adjusted to overcome the attenuation enough to present a received power level of at least −30 dBm (e.g., 1 microwatt) at the output of the receive antenna of the wireless sensor node, which is presented to the input of a passive frequency multiplier circuit within the wireless sensor node. In at least one embodiment, a transmission line matching network may couple the input of the frequency multiplier circuit to the receive antenna, providing a conjugate match between the two components for maximal power transfer.

At operation 504, in at least one embodiment, the interrogation signal is converted to a return signal (e.g., the response signal) within the wireless sensor node. In at least one embodiment, the passive frequency multiplier circuit may create harmonics (e.g., 2f₀, 3f₀, 4f₀, etc.) of the interrogation signal frequency. In at least one embodiment, harmonics may be present at the output of the frequency multiplier circuit, and fed to a transmission line matching network that is coupled to a transmit antenna. In at least one embodiment, transmission line matching network may provide a narrow-band tuned conjugate match between the transmit antenna and the output of the frequency multiplier circuit, enabling maximum power transfer, as well as filtering out unwanted harmonics. In at least one embodiment, matching network may be tuned to the first harmonic 2f₀. As an example, f₀ may be 1.2 GHZ, and 2f₀ may be 2.4 GHz.

In at least one embodiment, the frequency multiplier circuit may be operational to produce a conversion gain (CG) of at least −15 dB (e.g., output power approximately 1/30^{th} of the input power), where the conversion gain may be defined as CG=Pₒᵤₜ/Pᵢₙ, where Pᵢₙ is the power of the interrogation signal at f₀ present at the input of the frequency multiplier circuit, and Pₒᵤₜ is the power of the response signal at 2f₀, for example, presented to the transmit antenna. In at least one embodiment, power of the response signal at the input of the transmit antenna may be −45 dBm (e.g., approximately 300 nanowatts at 2f₀).

At operation 506, in at least one embodiment, the response signal is transmitted to the interrogator transceiver by the wireless sensor node. In at least one embodiment, response signal propagates through the medium and is attenuated by at least one of the mechanisms enumerated above. In at least one embodiment, the response signal is attenuated by partial absorption of the response signal by dielectric interactions with one or more components of the medium. In at least one embodiment, moisture within a railroad ballast material may have a strong absorbance at the frequency of the response signal (e.g., 2.4 GHZ). In at least one embodiment, amount of attenuation may depend on the embedment depth of the wireless sensor node within the medium, as well as a distance of up to 50 meters of the position of the interrogator transceiver to the point on the medium bed where the wireless sensor node is located. In at least one embodiment, the embedment depth may be 100 cm or less.

At operation 508, in at least one embodiment, the interrogator transceiver receives the attenuated response signal. In at least one embodiment, a circuit within the interrogator transceiver (e.g., received power measurement circuit 110) may be operational to measure the received power level of the response signal. In at least one embodiment, circuit may be coupled to a processor, which may read the received power level as binary data (converted from an analog voltage proportional to the received power level, for example). In at least one embodiment, processor may be a microprocessor integrated within the interrogator transceiver, or on a stand-alone computer, such as a laptop.

At operation 510, in at least one embodiment, the processor determines the attenuation level of the received response signal. In at least one embodiment, processor is coupled to a memory in which supporting data may be stored. In at least one embodiment, pre-measured received power level data may be stored in the memory, whereby the pre-measured data is correlated to known moisture levels in railroad ballast material. To determine the attenuation level (e.g., in dB), the measured received power level of the response signal may be read by the processor and compared to a pre-measured reference power level of a received response signal sent by an identical wireless sensor node. In at least one embodiment, the identical wireless sensor node was embedded at the same depth within a dry and clean ballast material (e.g., substantially zero moisture content). In at least one embodiment, two received power levels may be subtracted by the processor to determine the degree of attenuation by the moisture content within the fouled ballast material. In this manner, attenuation due to absorption by moisture is determined assuming the other components within the ballast material, such as the gravel composition and size, porosity and amount of coal dust, are substantially constant. The other attenuation mechanisms enumerated above are subtracted out by this method, in accordance with at least one embodiment.

At operation 512, in at least one embodiment, the processor correlates the determined attenuation to moisture content within the ballast material. In at least one embodiment, attenuation may be related to the tan δ loss of the response signal due to water absorption. In at least one embodiment, tan δ loss magnitude may be modeled to be proportional to moisture content, in terms of a weight or volumetric percentage of water within the ballast material. In at least one embodiment, the following semiempirical equation (1), written below, may be employed to determine (e.g., extract) tan δ from the measured attenuation:

$$α = ω \sqrt{\frac{{μ}_{0} {ε}_{0} {ε}^{′}}{2} [ \sqrt{1 + {tan}^{2} δ} - 1 ]} \times 8.686 dB / m \qquad ( 1 )$$

where α is the measured attenuation, ω is the frequency in rad/s, μ₀ is the permeability of free space, ε₀ is the permittivity of free space, ε′ is the real component of the dielectric constant, and δ is the phase angle between the real and imaginary components of the dielectric constant. The attenuation is expressed as dB/m. In at least one embodiment, the burial depth of the wireless sensor node (e.g., d₁ shown in FIG. 3), may also be a parameter read by the processor. The magnitude of tan δ may be proportional to the moisture level within the ballast material, and the relationship may be predetermined by systematic measurements of return signal attenuation by known ballast material moisture levels.

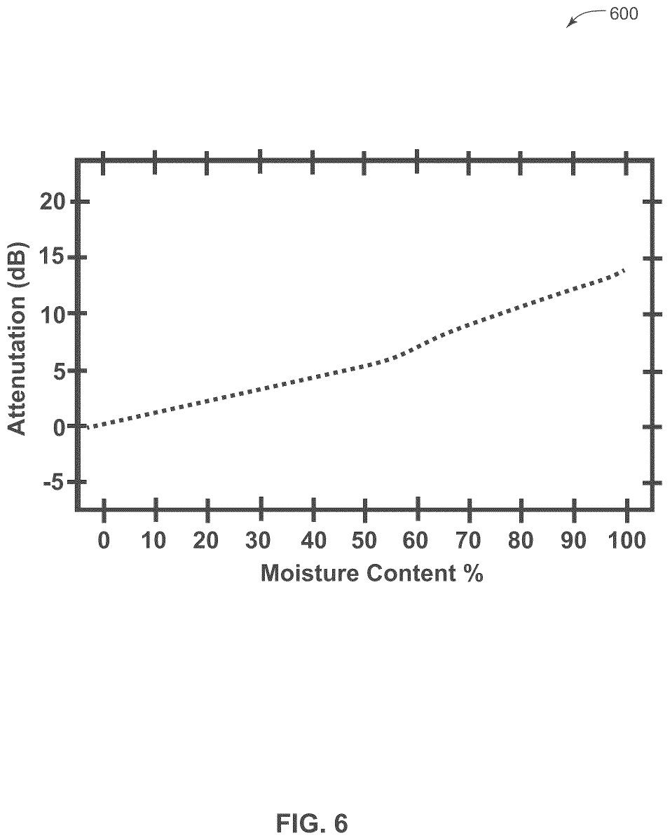

A relationship between attenuation and moisture content in a railroad ballast material, expressed as a volumetric percentage, may be pre-determined and expressed as plot 600 shown in FIG. 6. In at least one embodiment, plot 600 of FIG. 6 shows an approximately linear relationship between attenuation and moisture level. In at least one embodiment, smoothed data from plot 600 may be read into a look-up table or other variable type within the memory. In at least one embodiment, the processor may correlate the determined attenuation with a value of moisture level within the ballast material.

The following examples are provided that illustrate at least one embodiment. An example can be combined with any other example. As such, at least one embodiment can be combined with at least another embodiment without changing the scope of the disclosure.

Example 1 is a sensor, comprising an interrogator transceiver, wherein the interrogator transceiver is operable to transmit a first wireless signal at a first RF frequency and to receive a second wireless signal at a second RF frequency; a wireless sensor node embedded within a medium comprising one or more dielectric materials, wherein the wireless sensor node is interrogatable by the interrogator transceiver, wherein the wireless sensor node is operable to receive the first wireless signal at the first RF frequency from the interrogator transceiver and to transmit the second wireless signal at the second RF frequency to the interrogator transceiver; and a processor coupled to a circuit within the interrogator transceiver, wherein the circuit is operable to measure a power level of a received signal, and wherein the processor is operable to correlate the power level of the received signal to a composition of the medium, and wherein the received signal is the second wireless signal.

Example 2 is a sensor according to any example herein, in particular example 1, wherein the interrogator transceiver is portable.

Example 3 is a sensor according to any example herein, in particular example 1, wherein the wireless sensor node is a passive device, and wherein the wireless sensor node is operable to be activated by the first wireless signal.

Example 4 is a sensor according to any example herein, in particular example 1, wherein the wireless sensor node is housed within a foam enclosure.

Example 5 is a sensor according to any example herein, in particular example 1, wherein the second RF frequency is a harmonic of the first RF frequency.

Example 6 is a sensor according to any example herein, in particular example, 1, wherein the wireless sensor node comprises a receive antenna and a transmit antenna, wherein the receive antenna is coupled to an input of a frequency multiplier circuit, and wherein the transmit antenna is coupled to an output of the frequency multiplier circuit.

Example 7 is a sensor according to any example herein, in particular example 6, wherein the input of the frequency multiplier circuit comprises a DC bias circuit coupled to the input of the frequency multiplier circuit.

Example 8 is a sensor according to any example herein, in particular example 6, wherein the frequency multiplier circuit has a conversion gain of at least −15 dB relative to a power of the first wireless signal of −30 dBm at the input of the frequency multiplier circuit.

Example 9 is a sensor according to any example herein, in particular example 6, wherein the frequency multiplier circuit comprises a diode.

Example 10 is a sensor according to any example herein, in particular example 1, wherein the processor is operable to correlate the power level of the received signal to an attenuation of the received signal from absorption of the received signal by the one or more dielectric materials of the medium.

Example 11 is a sensor according to any example herein, in particular example 10, wherein the processor is operable to determine a content of a material comprised by the one or more dielectric materials of the medium, wherein the processor is operable to determine the attenuation of the second wireless signal by the material and wherein the processor is operable to correlate the attenuation of the second wireless signal to the content of the material in the medium.

Example 12 is a sensor according to any example herein, in particular example 10, wherein the one or more dielectric materials comprises water, and wherein the processor is operable to determine a moisture content of the medium, wherein the processor is operable to determine the attenuation of the second wireless signal by water, and wherein the processor is operable to correlate the attenuation of the second wireless signal to the moisture content of the medium.

Example 13 is a wireless sensor network, comprising one or more interrogator transceivers, wherein the one or more interrogator transceivers is operable to transmit a first wireless signal at a first RF frequency and to receive a second wireless signal at a second RF frequency; one or more wireless sensor nodes embedded within one or more media, wherein the one or more media comprise one or more dielectric materials, wherein the one or more wireless sensor nodes are interrogatable by the one or more interrogator transceivers, wherein the one or more wireless sensor nodes are operable to receive the first wireless signal at the first RF frequency from the one or more interrogator transceivers and to transmit the second wireless signal at the second RF frequency to the one or more interrogator transceivers; and a processor coupled to a circuit within the one or more interrogator transceivers, wherein the circuit is operable to measure a power level of a received signal, wherein the processor is operable to correlate the power level of the received signal to a composition of the one or more media, and wherein the received signal is the second wireless signal.

Example 14 is a wireless sensor network according to any example herein, in particular example 13, wherein the one or more interrogator transceivers are portable.

Example 15 is a wireless sensor network according to any example herein, in particular example 14, wherein the one or more interrogator transceivers are carried by one or more mobile vehicles.

Example 16 is a wireless sensor network according to any example herein, in particular example 15, wherein the one or more mobile vehicles are operable to travel along a rail.

Example 17 is a wireless sensor network according to any example herein, in particular example 16, wherein the one or more wireless sensor nodes are collocated along the rail, and wherein the one or more wireless sensor nodes are embedded within a ballast material under the rail.

Example 18 is a wireless sensor network according to any example herein, in particular example 17, wherein the processor is operable to determine a moisture content of the ballast material, wherein the processor is operable to determine an attenuation of the second wireless signal from absorption of the second wireless signal by water, and wherein the processor is operable to correlate the attenuation of the second wireless signal to the moisture content of the ballast material.

Example 19 is a wireless sensor network according to any example herein, in particular example 17, wherein the one or more wireless sensor nodes are embedded a distance below a surface of the ballast material.

Example 20 is a wireless sensor network according to any example herein, in particular example 19, wherein the distance below the surface of the ballast material is 100 cm or less.

Example 21 is a method for operating a wireless sensor network, comprising sending a first wireless signal from an interrogator transceiver to a wireless sensor node embedded within a medium comprising one or more dielectric materials, wherein the wireless sensor node is embedded at a distance below a surface of the medium; converting the first wireless signal to a second wireless signal within a circuit of the wireless sensor node; transmitting the second wireless signal from the wireless sensor node, wherein the second wireless signal is received by the interrogator transceiver; measuring a received power level of the second wireless signal by a circuit within the interrogator transceiver; determining an attenuation of the second wireless signal by a processor coupled to the circuit; and correlating the attenuation of the second wireless signal to a content of a dielectric material comprised by the medium.

Example 22 is a method according to any example herein, in particular example 21, wherein converting the first wireless signal to the second wireless signal comprises converting the first wireless signal to a harmonic of the first wireless signal, wherein the second wireless signal comprises the harmonic of the first wireless signal, wherein the wireless sensor node comprises a frequency multiplier circuit operable to convert the first wireless signal to the second wireless signal, wherein an input of the frequency multiplier circuit is coupled to a first antenna operable to receive the first wireless signal, and wherein an output of the frequency multiplier circuit is coupled to a second antenna operable to transmit the second wireless signal.

Example 23 is a method according to any example herein, in particular example 21, wherein determining the attenuation of the second wireless signal comprises determining a ratio of a measured power level of the second wireless signal received by the interrogator transceiver, wherein the second wireless signal is attenuated as it travels through the medium the distance below the surface of the medium, to a reference power level of the second wireless signal.

Example 24 is a method according to any example herein, in particular example 21, wherein correlating the attenuation of the second wireless signal to the content of the dielectric material within the medium comprises correlating the attenuation of the second wireless signal to a loss tangent of the medium, wherein the loss tangent of the medium is proportional to the content of the dielectric material within the medium.

Example 25 is a method according to any example herein, in particular example 21, wherein correlating the attenuation of the second wireless signal to the content of the dielectric material within the medium comprises correlating the attenuation of the second wireless signal to a moisture content within a railroad ballast material.

Example 26 is a method according to any example herein, in particular example 25, wherein correlating the attenuation of the second wireless signal to the moisture content within the railroad ballast material comprises determining a loss tangent of the railroad ballast material from the attenuation of the second wireless signal, wherein the attenuation of the second wireless signal is mathematically related to the loss tangent of the railroad ballast material, and wherein the loss tangent of the railroad ballast material is proportional to the moisture content of the railroad ballast material.

Besides what is described herein, various modifications can be made to disclosed implementations and implementations thereof without departing from their scope. Therefore, illustrations of implementations herein should be construed as examples, and not restrictive to scope of present disclosure.

What is claimed is:

1. A sensor, comprising:
an interrogator transceiver, wherein the interrogator transceiver is operable to transmit a first wireless signal at a first RF frequency and to receive a second wireless signal at a second RF frequency;
a wireless sensor node embedded within a medium comprising one or more dielectric materials, wherein the wireless sensor node is interrogatable by the interrogator transceiver, wherein the wireless sensor node is operable to receive the first wireless signal at the first RF frequency from the interrogator transceiver and to transmit the second wireless signal at the second RF frequency to the interrogator transceiver; and
a processor coupled to a circuit within the interrogator transceiver, wherein the circuit is operable to measure a power level of a received signal, and wherein the processor is operable to correlate the power level of the received signal to a composition of the medium, and wherein the received signal is the second wireless signal.

2. The sensor of claim 1, wherein the interrogator transceiver is portable.

3. The sensor of claim 1, wherein the wireless sensor node is a passive device, and wherein the wireless sensor node is operable to be activated by the first wireless signal.

4. The sensor of claim 1, wherein the wireless sensor node is housed within a foam enclosure.

5. The sensor of claim 1, wherein the second RF frequency is a harmonic of the first RF frequency.

6. The sensor of claim 1, wherein the wireless sensor node comprises a receive antenna and a transmit antenna, wherein the receive antenna is coupled to an input of a frequency multiplier circuit, and wherein the transmit antenna is coupled to an output of the frequency multiplier circuit.

7. The sensor of claim 6, wherein the input of the frequency multiplier circuit comprises a DC bias circuit coupled to the input of the frequency multiplier circuit.

8. The sensor of claim 6, wherein the frequency multiplier circuit has a conversion gain of at least −15 dB relative to a power of the first wireless signal of −30 dBm at the input of the frequency multiplier circuit.

9. The sensor of claim 6, wherein the frequency multiplier circuit comprises a diode.

10. The sensor of claim 1, wherein the processor is operable to correlate the power level of the received signal to an attenuation of the received signal from absorption of the received signal by the one or more dielectric materials of the medium.

11. The sensor of claim 10, wherein the processor is operable to determine a content of a material comprised by the one or more dielectric materials of the medium, wherein the processor is operable to determine the attenuation of the second wireless signal by the material and wherein the processor is operable to correlate the attenuation of the second wireless signal to the content of the material in the medium.

12. The sensor of claim 10, wherein the one or more dielectric materials comprises water, and wherein the processor is operable to determine a moisture content of the medium, wherein the processor is operable to determine the attenuation of the second wireless signal by water, and wherein the processor is operable to correlate the attenuation of the second wireless signal to the moisture content of the medium.

13. A wireless sensor network, comprising:
one or more interrogator transceivers, wherein the one or more interrogator transceivers is operable to transmit a first wireless signal at a first RF frequency and to receive a second wireless signal at a second RF frequency;
one or more wireless sensor nodes embedded within one or more media, wherein the one or more media comprise one or more dielectric materials, wherein the one or more wireless sensor nodes are interrogatable by the one or more interrogator transceivers, wherein the one or more wireless sensor nodes are operable to receive the first wireless signal at the first RF frequency from the one or more interrogator transceivers and to transmit the second wireless signal at the second RF frequency to the one or more interrogator transceivers; and
a processor coupled to a circuit within the one or more interrogator transceivers, wherein the circuit is operable to measure a power level of a received signal, wherein the processor is operable to correlate the power level of the received signal to a composition of the one or more media, and wherein the received signal is the second wireless signal.

14. The wireless sensor network of claim 13, wherein the one or more interrogator transceivers are portable.

15. The wireless sensor network of claim 14, wherein the one or more interrogator transceivers are carried by one or more mobile vehicles.

16. The wireless sensor network of claim 15, wherein the one or more mobile vehicles are operable to travel along a rail.

17. The wireless sensor network of claim 16, wherein the one or more wireless sensor nodes are collocated along the rail, and wherein the one or more wireless sensor nodes are embedded within a ballast material under the rail.

18. The wireless sensor network of claim 17, wherein the processor is operable to determine a moisture content of the ballast material, wherein the processor is operable to determine an attenuation of the second wireless signal from absorption of the second wireless signal by water, and wherein the processor is operable to correlate the attenuation of the second wireless signal to the moisture content of the ballast material.

19. The wireless sensor network of claim 17, wherein the one or more wireless sensor nodes are embedded a distance below a surface of the ballast material.

20. The wireless sensor network of claim 19, wherein the distance below the surface of the ballast material is 100 cm or less.

21. A method for operating a wireless sensor network, comprising:
sending a first wireless signal from an interrogator transceiver to a wireless sensor node embedded within a medium comprising one or more dielectric materials,
wherein the wireless sensor node is embedded at a distance below a surface of the medium;
converting the first wireless signal to a second wireless signal within a circuit of the wireless sensor node;
transmitting the second wireless signal from the wireless sensor node, wherein the second wireless signal is received by the interrogator transceiver;
measuring a received power level of the second wireless signal by a circuit within the interrogator transceiver;
determining an attenuation of the second wireless signal by a processor coupled to the circuit; and
correlating the attenuation of the second wireless signal to a content of a dielectric material comprised by the medium.

22. The method of claim 21, wherein converting the first wireless signal to the second wireless signal comprises converting the first wireless signal to a harmonic of the first wireless signal, wherein the second wireless signal comprises the harmonic of the first wireless signal, wherein the wireless sensor node comprises a frequency multiplier circuit operable to convert the first wireless signal to the second wireless signal, wherein an input of the frequency multiplier circuit is coupled to a first antenna operable to receive the first wireless signal, and wherein an output of the frequency multiplier circuit is coupled to a second antenna operable to transmit the second wireless signal.

23. The method of claim 21, wherein determining the attenuation of the second wireless signal comprises determining a ratio of a measured power level of the second wireless signal received by the interrogator transceiver, wherein the second wireless signal is attenuated as it travels through the medium the distance below the surface of the medium, to a reference power level of the second wireless signal.

24. The method of claim 21, wherein correlating the attenuation of the second wireless signal to the content of the dielectric material within the medium comprises correlating the attenuation of the second wireless signal to a loss tangent of the medium, wherein the loss tangent of the medium is proportional to the content of the dielectric material within the medium.

25. The method of claim 21, wherein correlating the attenuation of the second wireless signal to the content of the dielectric material within the medium comprises correlating the attenuation of the second wireless signal to a moisture content within a railroad ballast material.

26. The method of claim 25, wherein correlating the attenuation of the second wireless signal to the moisture content within the railroad ballast material comprises determining a loss tangent of the railroad ballast material from the attenuation of the second wireless signal, wherein the attenuation of the second wireless signal is mathematically related to the loss tangent of the railroad ballast material, and wherein the loss tangent of the railroad ballast material is proportional to the moisture content of the railroad ballast material.
